(19) United States
(12) Patent Application Publication
(10) Pub. No.: US 2010/0206807 A1
(43) Pub. Date: Aug. 19, 2010

(54) Municipal septic tank biogas collection system and method

(76) Inventors: Dana Kirk Ripley, Pleasanton, CA (US); Dana Cameron Ripley, San Luis Obispo, CA (US); Michael Thomas Huck, Dana Point, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/378,468

(22) Filed: Feb. 13, 2009

(51) Int. Cl. C02F 3/00

(52) U.S. Cl. 210/603; 210/188

(57) ABSTRACT

A biogas collection system and method for collecting and utilizing biogas that is produced as a byproduct of anaerobic digestion in a wastewater treatment system having one or more wastewater sources. The biogas collection system comprises an interceptor or septic tank hydraulically connected to the wastewater sources to receive wastewater therein and to generate effluent and biogas from the anaerobic digestion of the wastewater. The system has a wastewater treatment facility hydraulically connected to the interceptor tank by one or more effluent lines and a biogas processing facility hydraulically connected to the interceptor tank by one or more biogas pipelines. Biogas inside the effluent lines is compressed and transported to the biogas processing facility to be utilized as a fuel for power generation or processed to reduce the greenhouse gas effect of the biogas. The biogas collection is a closed system that does not vent biogas to the atmosphere.

### CROSS-REFERENCE TO RELATED APPLICATIONS

None.

### STATEMENT REGARDING FEDERALLY SPONSORED RESEARCH

Not Applicable.

### BACKGROUND OF THE INVENTION

A. Field of the Invention

The field of the present invention relates generally to systems and methods of treating municipal wastewater and handling greenhouse gases that are associated with wastewater. More specifically, the present invention relates to such systems and methods that transport treated effluent from septic tanks to a wastewater treatment facility for further treatment and distribution. Even more specifically, the present invention relates to such wastewater treatment systems and methods that collect and process biogas to produce electricity and/or reduce greenhouse gas emissions.

B. Background

Public and private entities are increasingly concerned with the cost of collecting and treating municipal wastewater and the impact that these activities have on the production of greenhouse gases and global warming. The typical standard wastewater treatment system comprises a source of wastewater, such as a home, school, business or other private or public building, a piping system that includes local pipes and sewer lines to transport wastewater away from the building, and a wastewater treatment facility that receives the wastewater via the sewer lines. Typically, the piping system is configured such that the wastewater flows via gravity through the local pipes and the sewer lines to the wastewater treatment facility. Gravity flow systems require the treatment facility be placed at a geographically low location and the lines to be buried in such a manner that the wastewater continually flows downhill to the treatment facility. If necessary due to the terrain, pumps are used to assist the delivery of wastewater to the treatment facility. At the treatment facility, organic wastes are collected from the physical and biological treatment processes and pumped into anaerobic digesters. In the past, the biogas produced by the anaerobic digesters was usually vented to the atmosphere. Modern wastewater treatment systems generally collect the biogas from the anaerobic digesters and transport it to a biogas-fueled power generation facility or combust the biogas. Use of the biogas for power generation allows the operator to recover some of the costs associated with the wastewater treatment system and reduce the amount of greenhouse gases generated by the system.

In areas where municipal wastewater treatment systems having standard sewer lines are not possible or practical, such as in rural or other low density areas and in areas where the terrain is not suitable for sewer lines and/or the treatment facility itself, wastewater producers usually rely on septic tank systems. The typical septic tank system transports wastewater from a source to a nearby septic tank, which is buried in the ground below an open ground area. Septic tanks provide an anaerobic bacterial environment that decomposes the wastes discharged into the tank. The liquid component of the waste and the decomposed waste are combined in the septic tank (the fluid is commonly referred to as treated effluent) and then flows or is pumped out the septic tank to a leach or drain field. Impurities remaining in the treated effluent decompose in the soil and the water percolates to the groundwater or is taken up by the roots of nearby plants and/or trees. The size of the leach or drain field required for the septic system is proportional to the volume of wastewater handled by the system and inversely proportional to the porosity of the drainage area. The solid waste that is not decomposed by the anaerobic process has to be removed from the septic tank in order to avoid filling up the tank and causing overflow of untreated wastewater to the leach or drain field, which can result in damage to the drainage area. Biogas produced in the septic tank is vented to the atmosphere.

A relatively modern approach to wastewater treatment combines various aspects of the centralized treatment facility systems and septic tank systems. These systems are commonly referred to as septic tank effluent pump (STEP) and septic tank effluent gravity (STEG) systems. A typical STEP system comprises a septic tank that is associated with one or more wastewater sources, a pump to pump effluent from the septic tank, a network of relatively small diameter pipes to transport effluent from the septic tanks and a treatment facility to receive and treat the effluent. A typical STEG system comprises the same basic components as a STEP system except the effluent flows by gravity from the septic tank to the treatment facility, thereby eliminating the need for the pump. In either system, the pipes are usually made out of plastic and are much smaller in diameter than conventional sewer pipes. Because effluent flows under pressure, whether pumped or due to gravity, the pipes can generally follow the contour of the terrain and it is not necessary to bury them as deep as is required for standard sewer pipes, thereby significantly reducing the cost of constructing the wastewater transport system. In addition, it is generally less likely that wastewater will seep out of the system and for other water, such as rain drainage water, to enter the system. Although the wastewater treatment facility typically collects and utilizes or transports for use the biogas produced at the facility, the biogas produced in the septic tanks is vented to the atmosphere through sewer lines that connect to a vent, usually at the roof of the building from which the wastewater originated. Air release valves on the effluent piping are placed at the high points in the system to release biogas that accumulates in the piping. It is generally recognized by persons knowledgeable in the wastewater treatment industry that one of the primary disadvantages of a STEP system, relative to a gravity flow treatment facility system and a localized septic tank system, is the cost of electricity for the pumps. From an environmental perspective, particularly with regard to global warming, venting of biogas from the septic tanks and the increased energy usage of any pumps are adverse impacts that are likely to negatively effect regulatory approval of a STEP or STEG system.

The impact of human activities on global warming has taken on more importance to many people in recent years. It is commonly believed that global warming is adversely affecting the environment and, unless steps are taken to reduce its causes and/or counteract its effects, the environmental problems associated with global warming will increase in severity and scope over time. Increases in greenhouse gases, particularly carbon dioxide, nitrogen oxides, methane, fluorocarbons and the like, in the atmosphere result in increased global warming by absorbing energy that is irradiated from the earth's surface, which raises the temperature on the surface of the earth. The potential greenhouse effect of various gases are commonly compared utilizing a greenhouse gas (or GHG) indicator that represents how much warming effect one unit weight of a gas has compared to one unit weight of carbon dioxide. Methane, for instance, has a GHG effect that is approximately 21 times greater than that for carbon dioxide. Based on this analysis, each unit weight of methane is believed to be 21 times worse for global warming than an equivalent unit weight of carbon dioxide. As a result of the concerns regarding global warming, many individuals and private and public entities are taking steps to reduce the global warming impact of their activities and the activities of others. In some circumstances, this consideration is being mandated by law. For instance, in California the Global Warming Solutions Act of 2006, which is also know as AB 32, sets forth greenhouse gas emission reductions goals and authorizes the California Air Resources Board to develop regulations and market mechanisms to meet the state's emissions targets.

Presently, wastewater treatment is considered an energy-consuming and waste-producing activity. In fact, the typical composition of biogas is 50% to 75% methane and 25% to 50% carbon dioxide. Because biogas is commonly vented or lost to the atmosphere, wastewater treatment is considered a major contributor to the problems associated with greenhouse gases. Although many wastewater treatment facility systems collect biogas and either utilize or transport it for use to produce energy, much of the biogas is lost to the system before the wastewater reaches the treatment facility. It is generally not considered practical to collect and utilize biogas produced in standard septic tank systems and, as a result, the biogas is vented to the atmosphere. The modern STEP and STEG systems have the biogas collection and utilization issues of both the treatment facility systems and septic tank systems.

What is desired, therefore, is an improved system and method for capturing and transporting biogas in STEP/STEG systems so the biogas may be utilized to generate energy in order to at least partially offset the operational costs of such systems and to reduce the discharge or loss of biogas to the atmosphere in order to lessen the greenhouse gas production and the overall GHG effect from wastewater treatment. The preferred system and method should efficiently and effectively capture the biogas and transport it to a facility for producing energy or combusting it to a less environmentally harmful substance. Preferably, the system and method should be relatively easy to install and not significantly increase the cost of installing the wastewater treatment system.

### SUMMARY OF THE INVENTION

The municipal septic tank biogas collection system and method of the present invention provides the benefits and solves the problems identified above. That is to say, the present invention discloses a biogas collection system and method configured for use with a STEP/STEG system to collect biogas from the septic tanks and pipelines utilized in the system and transport the biogas to a processing facility where the biogas can be utilized to produce electricity or be combusted to a lower GHG effect product. In the preferred embodiment, the biogas collection system and method of the present invention provides a closed biogas system that substantially improves the amount of biogas which can be beneficially utilized or beneficially processed by a wastewater treatment system and substantially reduces the greenhouse gases emitted by the wastewater treatment system. The present biogas collection system and method can be easily incorporated into a STEP/STEG system for relatively low additional costs, thereby not significantly impacting the cost of installing a wastewater treatment system.

In one aspect of the biogas collection system and method of the present invention, the system comprises one or more wastewater sources, such as homes, schools, businesses, private and public facilities and the like, that each generate wastewater. The wastewater is transported to one or more interceptor tanks that are configured as a closed septic tank to anaerobically digest the wastewater and generate a quantity of effluent and a quantity of biogas. Unlike prior art wastewater systems, the biogas is not vented from the interceptor tanks. The effluent is transported through one or more effluent lines to a wastewater treatment facility where it is processed for reuse, typically for non-potable uses such as lawn watering, toilet flushing, emergency fire suppression and the like. The biogas is collected at the top of the interceptor tanks, from which a small compressor pushes the biogas through one or more biogas pipelines to a biogas processing facility that processes the biogas in an environmentally friendly manner. The effluent lines can have one or more air release valves, typically at the geographically high points of the terrain, that are connected to a nearby biogas pipeline to transfer biogas from the effluent line to the biogas pipeline and then to the biogas processing facility. Preferably, the effluent lines and the biogas pipelines are placed inside the same trench and the biogas processing facility is at the wastewater treatment facility to reduce construction and operating costs. In one embodiment, the biogas processing facility is configured to generate electrical power using the biogas as a fuel. In another embodiment, the biogas processing facility is configured to combust the biogas to reduce the GHG effect thereof. In yet another embodiment, the biogas processing facility is configured to both generate electrical power and combust the biogas.

Accordingly, the primary objective of the present invention is to provide an improved municipal septic tank biogas collection system and method that provides the advantages discussed above and overcomes the disadvantages and limitations associated with presently available municipal septic tank systems and methods.

An important objective of the present invention is to provide a biogas collection system and method that collects biogas produced in the septic tanks and effluent pipelines of a wastewater treatment system, particularly a STEP or STEG system, to provide a closed biogas system which allows the operator to better utilize and/or process the biogas and reduce greenhouse gases that are normally associated with the wastewater treatment system. A related object of the present invention is to allow the operator of the wastewater treatment system to better utilize the biogas for production of electricity or other beneficial uses.

Another important objective of the present invention is to provide a biogas collection system and method that reduces the environmental impact of a STEP/STEG system by substantially reducing the greenhouse gases discharged by the system and provide for substantially improved utilization of the biogas for energy production purposes so as to ease regulatory approval of such systems.

Yet another important objective of the biogas collections system and method of the present invention is to reduce the costs associated with operating a STEP or STEG system by utilizing biogas produced by the system to generate electricity that can be used by the wastewater treatment system or sold into an electrical power grid.

The above and other aspects and objectives of the present invention are explained in greater detail by reference to the attached figures and the description of the preferred embodiments which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a schematic view of a prior art STEP/STEG system showing collection and transport of the effluent to a wastewater treatment facility and the venting of biogas from the system;

FIG. 2 is a schematic view of a municipal septic tank biogas collection system configured according to a preferred embodiment of the present invention showing the biogas being collected from the interceptor tanks and effluent pipelines;

FIG. 3 is an end view of an interceptor tank showing use of a compressor to pump biogas from the top of the interceptor tank through a biogas pipeline;

FIG. 4 is a cross-sectional view of a trench showing the placement of an effluent line and a biogas pipeline in the same trench to reduce construction costs; and

FIG. 5 is a chart summarizing the method of using the biogas collecting system of the present invention.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The foregoing description and enclosed drawings are merely illustrative of one or more of the preferred embodiments and, as such, represent one or more ways of configuring the present invention. Although specific components, materials, configurations and uses are described and illustrated, it should be understood that a number of variations to the components and to the configuration of those components described herein and in the accompanying figures can be made without changing the scope and function of the invention set forth herein. For instance, although the figures and description provided herein primarily describe the biogas being utilized for the production of electricity, those skilled in the art will readily understand that this is merely for purposes of simplifying the present disclosure and that the present invention is not so limited.

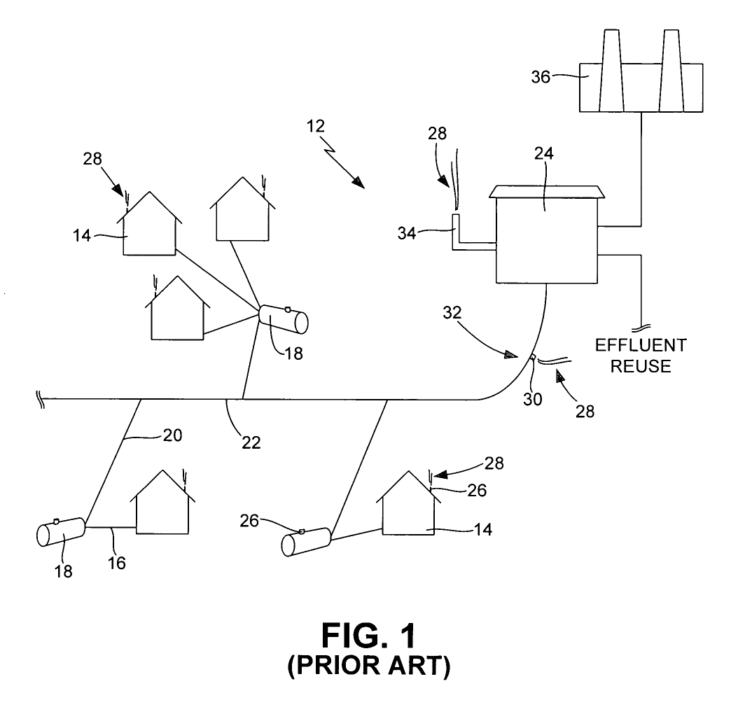

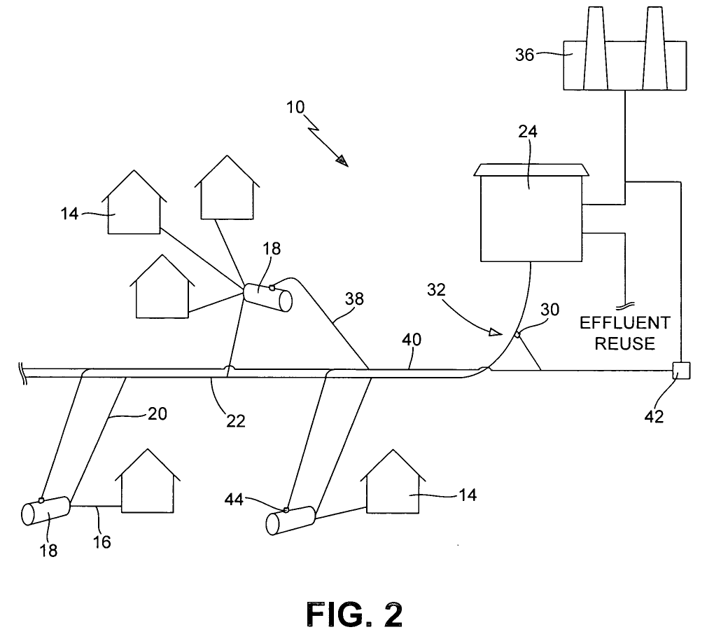

A municipal septic tank biogas collection system that comprises the components and is configured pursuant to a preferred embodiment of the present invention is shown generally as 10 in FIG. 2. As set forth in more detail below, the biogas collection system 10 provides significant benefits over a standard prior art STEP/STEG system, shown as 12 in FIG. 1, including increased energy production and reduction in greenhouse gases. A prior art STEP/STEG system 12 comprises one or more wastewater sources 14, such as a home, school, business and other public or private buildings, that produce wastewater from the sinks, toilets, baths, laundries, kitchens and other wastewater producing components of the various wastewater sources 14. Typically, the wastewater is piped through conventional gravity sewer lines 16 to an interceptor tank 18 that is associated with wastewater source 14 or a plurality of wastewater sources 14 (such as a residential cluster or a community area). Interceptor tank 18 provides an anaerobic environment that decomposes the wastes from the source 14 to pre-treat the wastewater. For STEP systems, effluent from the interceptor tank 18 is pumped, typically utilizing a low horsepower submersible effluent pump disposed inside interceptor tank 18, through a relatively small diameter local effluent line 20 to another relatively small diameter collection effluent line 22 that transports effluent to wastewater treatment facility 24 where the effluent is further treated and then discharged. For STEG systems, the effluent flows by gravity through effluent lines 20/22 to the wastewater treatment facility 24. Effluent discharged from the wastewater treatment facility 24 is commonly sent to storage ponds to percolate to the groundwater, reused on lawns, golf courses, right-of-way landscaping or other non-potable uses or (depending on the quality) discharged to surface water locations such as a lake or river.

The interceptor tank 18 is generally configured similar to a standard septic tank except that it intercepts the wastewater flow from the source 14 to the wastewater treatment facility 24 instead of discharging effluent to a leach field or the like. As shown in FIG. 1, each interceptor tank 18 is hydraulically connected to a vent 26, which is typically located at the source 14 via a sewer line or the like (not shown), to vent biogas, shown as 28, that accumulates in interceptor tank 18. The effluent lines 20 and/or 22 have air release valves 30 that are located at the higher elevation points, shown as 32, in the system 12 to release biogas that accumulates in the effluent lines 20/22. The wastewater treatment facility 24 of the prior art STEP/STEG system 12 is usually a large-sized centralized facility which receives effluent from a relatively large geographic area containing many wastewater sources 14. One or more anaerobic digesters at the wastewater treatment facility 24 collect the organic waste and produce biogas. The biogas received or produced by the wastewater treatment facility 24 either vents through one or more vent pipes 34 or is transported to a biogas processing facility 36, such as a power generation facility to produce electricity. Biogas processing facility 36 may be or additionally comprise a biogas combustion facility that is configured to combust the biogas from the wastewater treatment facility 24 by one or more processes familiar to those skilled in the art. As with wastewater treatment facility 24, the biogas processing facility 36 is typically a large scale processing facility that receives biogas from one or more sources of biogas.

As well known to those skilled in the art, while the standard prior art STEP/STEG system 12 is generally good at handling and processing effluent generated from the wastewater, it does not beneficially utilize or prevent the release of biogas 28 from interceptor tanks 18 and/or lines 20/22. In addition to the lost revenue opportunity that exists from using the biogas 28 to generate electricity, venting of the biogas 28 to the atmosphere is a significant source of greenhouse gases that contributes to the problems associated with global warming. Because biogas 28 primarily comprises methane, the GHG effect of the vented biogas 28 is much higher than a source that vents an equivalent amount of carbon dioxide. As a result of these and related environmental issues, regulatory approval of prior art STEP/STEG systems 12 have become or will become generally more difficult as the approving bodies consider the overall greenhouse impact of such systems, as is mandated by AB 32 in California (as an example).

The biogas collection system 10 of the present invention, shown in FIG. 2, primarily comprises the same components of the prior art STEP/STEG system 12 with the addition of components to collect and transport biogas from the interceptor tanks 18 and effluent lines 20/22, particularly from the high point 32 in the system 10. Instead of venting the biogas to the atmosphere as in the prior art STEP/STEG system 12, the interceptor tanks 18 of the biogas collecting system 10 are closed and one or more local biogas pipelines 38 and one or more collection biogas pipelines 40 transport biogas from the interceptor tanks 18 to the biogas processing facility 36. As shown in FIG. 2, the local biogas pipelines 38 connect the interceptor tanks 18 to the collection biogas pipeline 40, which takes the biogas directly to the biogas processing facility 36. As in the prior art system 12, the biogas processing facility 36 can comprise a power generation facility for the production of electricity and/or a combustion facility configured to combust the biogas so as to lower the GHG effect thereof by reducing the potency of the more harmful greenhouse gas emissions, such as the methane. As known to those skilled in the art, various biogas-fueled power generation facilities can be utilized to convert the biogas to electricity. Likewise, those skilled in the art will readily appreciate that a variety of combustion facilities can be utilize to lower the GHG effect of the biogas. If desired, a centralized compressor 42 can be utilized to pressurize the biogas to assist in transporting it to the biogas processing facility 36.

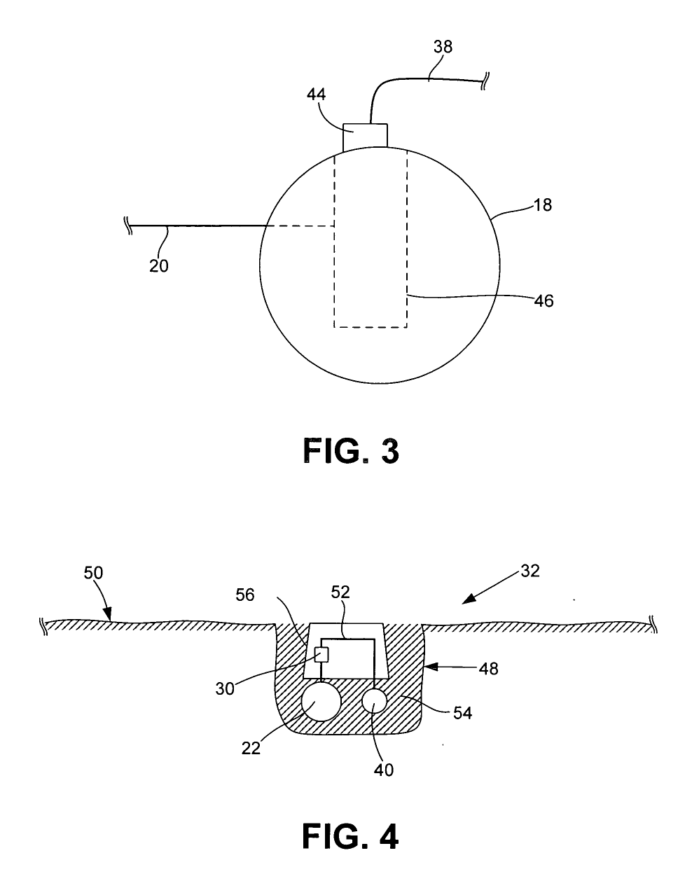

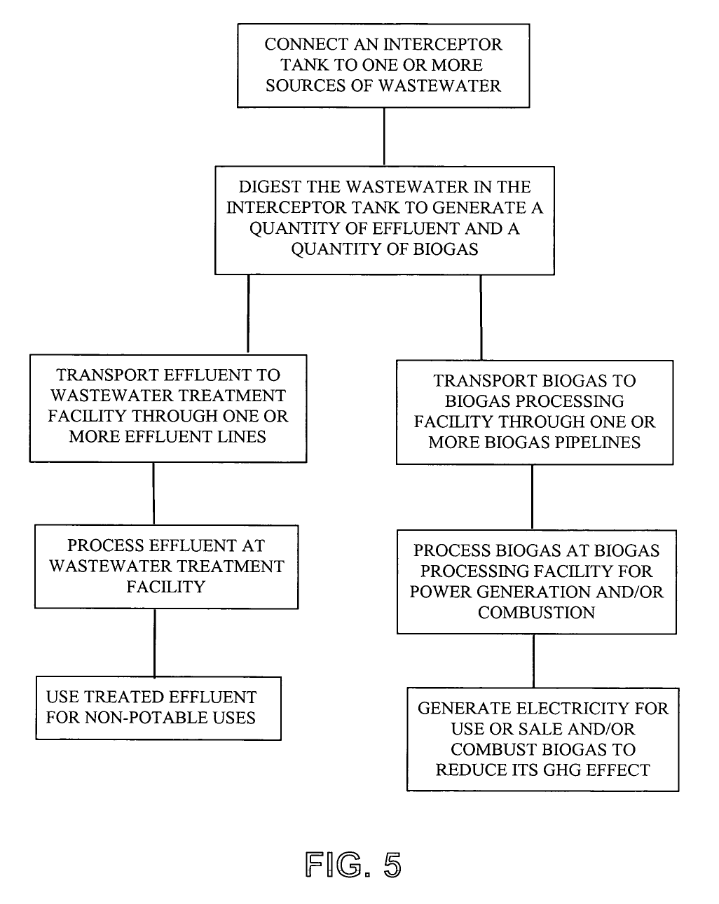

As best shown in FIG. 3, the preferred embodiment of the biogas collection system 10 includes a local compressor 44 at interceptor tank 18 to pressurize the biogas that accumulates at the top of interceptor tank 18. The compressor 44, which may be located outside interceptor tank 18 as shown or inside interceptor tank 18, is needed to convey the biogas through the biogas pipelines 38 and 40 to the biogas processing facility 36 for power generation and/or combustion. FIG. 3 also shows use of a low horsepower submersible effluent pump 46 hydraulically connected to interceptor tank 18, typically inside interceptor tank 18, to pump the effluent to the wastewater treatment facility 36 through effluent lines 20 and 22. With the local biogas pipelines 38 connected to the interceptor tanks 18, the air release valves 30 of effluent lines 20 and/or 22 connected to biogas pipelines 38 and/or 40 (as shown in FIG. 4) and the biogas from the wastewater treatment plant 24 directed to the biogas processing facility 36, the biogas collection system 10 is a closed system. The closed system collects accumulated air, which contain biogas, in pipelines 38/40 by pressure differential to prevent biogas in the liquid effluent lines 20/22 from being emitted to the atmosphere.

In a preferred embodiment of the biogas collection system 10 of the present invention, the biogas pipelines 38/40 are located in a common trench 48 with effluent lines 20/22, respectively. As shown in FIG. 4, trench 48 is provided in the ground 50 and both the collection effluent line 22 and the collection biogas pipeline 40, as an example, are placed in the trench 48. As shown, a connecting pipe 52 is utilized to connect air release valve 30 on collection effluent line 22 with the collection biogas pipeline 40 to transfer the biogas that accumulates at high point 32 from the effluent collecting system to the biogas collecting system so that it may be transported to the biogas processing facility 36 instead of being vented to the atmosphere. Once the effluent lines 20/22 and biogas pipelines 38/40 are placed inside trench 48, and connected (if appropriate) by connecting pipe 52, soil or other fill material 54 is placed in trench 48 to cover the effluent lines 20/22 and biogas pipelines 38/40. Preferably, a typical valve box or the like, shown as 56 in FIG. 4, is utilized at high point 32 to enclose air release valve 30 and connecting pipe 52 in order to provide easier access to these components for repair or replacement thereof.

In the preferred embodiment of the biogas collection system 10 of the present invention, the wastewater treatment facility 24 and the biogas processing facility 36 are located together to reduce the construction and operating costs. In a preferred use of biogas collection system 10, a small community, building complex, housing development or the like will utilize the biogas collection system 10 of the present invention to reclaim its effluent water and to generate electricity from its biogas production. The effluent water can be reused for toilet flushing, right-of-way watering, watering of sports fields or golf courses, front and/or back yard watering and as a source water for emergency fire suppression. The electricity generated by the biogas processing facility 36 can be used to provide power to the pressure pumps 44, lighting for common areas, power for operation of the wastewater treatment facility 24 and the biogas processing facility 36 and/or be fed into the power grid for monetary credit towards the electricity utilized by the owner or operator of the biogas collection system 10.

The use of the biogas collection system 10 of the present invention is summarized on the chart set forth in FIG. 5. As shown, the owner or operator of biogas collection system 10 operatively connects an interceptor tank 18 to one or more wastewater sources 14 so the wastewater is discharged to the interceptor tank 18. The interceptor tank 18 is configured as a septic tank that provides an anaerobic environment to digest the raw sewage and generate a quantity of effluent and a quantity of biogas inside interceptor tank 18. The effluent is transported to the wastewater treatment facility 24 through one or more effluent lines, such as local effluent line 20 and collection effluent line 22, for further processing and then reuse for various non-potable purposes. The biogas, which rises to the top of interceptor tank 18, is conveyed by a small compressor 44 to a biogas processing facility 36 through one or more biogas pipelines 38/40, such as local biogas pipeline 38 and collection biogas pipeline 40. The biogas processing facility 36 processes the biogas. If the biogas processing facility 36 is a power generation facility, the biogas is utilized as fuel to generate electricity. If the biogas processing facility 36 is a combustion facility, then the biogas is combusted to reduce the GHG effect of the biogas. In one embodiment, biogas coming into the biogas processing facility 36 is split into a first portion for use as a fuel to generate electricity at the power generation facility and into a second portion that is combusted to reduce its GHG effect. Depending on the fuel needs, the amount of the biogas that is diverted to the first portion for electricity or to the second portion for combustion can be varied by the operator.

Air release valves 30 on the effluent lines 20/22, typically at the geographic high point 32 of the terrain, are utilized to divert the accumulated air/biogas from the effluent lines 20/22 to the respective biogas pipelines 38/40 and, as a result, wastewater treatment facility 24. In the preferred embodiment, the effluent lines 20/22 and the biogas pipelines 38/40 are placed near each other inside the same trench 48 and the wastewater treatment facility 24 and biogas processing facility 36 are placed at the same location to reduce construction and operating costs. After biogas collection system 10 is constructed, it will require little manual input to run, except to address repairs or upgrades. If desired, the compressor 44 at the top of the interceptor tank 18 can operate on a timer and be set to regularly evacuate a known quantity of biogas from the interceptor tank 18. Alternatively, compressor 44 can be pressure-activated to operate when the biogas in interceptor tank 18 reaches a predetermined level. As set forth above, the closed system of the biogas collection system 10 allows virtually no biogas to vent to the atmosphere from either the conveyance or treatment components, resulting in a wastewater handling system that is more environmentally friendly than prior art systems and able to generate revenue from electricity generation that can be utilized to offset construction and operating costs.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to various modifications with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A biogas collection system, comprising:
one or more wastewater sources, each of said wastewater sources generating wastewater;
an interceptor tank hydraulically connected to said one or more wastewater sources, said interceptor tank configured to receive wastewater from said one or more wastewater sources and generate a quantity of effluent and a quantity of biogas;
a wastewater treatment facility configured to process said quantity of effluent;
one or more effluent lines hydraulically interconnecting said interceptor tank and said wastewater treatment facility, each of said one or more effluent lines configured to transport said quantity of effluent to said wastewater treatment facility;
a biogas processing facility configured to receive and process said quantity of biogas so as to beneficially utilize said quantity of biogas and/or reduce the GHG effect thereof; and
one or more biogas pipelines interconnecting said interceptor tank and said biogas processing facility, each of said one or more biogas pipelines configured to transport said quantity of biogas to said biogas processing facility.

2. The biogas collection system according to claim 1, wherein said biogas processing facility is a power generation facility configured to generate electricity utilizing said quantity of biogas.

3. The biogas collection system according to claim 1, wherein said biogas processing facility is a combustion facility configured to combust said quantity of biogas to reduce the GHG effect thereof.

4. The biogas collection system according to claim 1, wherein said biogas processing facility comprises a power generation facility configured to generate electricity utilizing a first portion of said quantity of biogas and a combustion facility configured to combust a second portion of said quantity of biogas to reduce the GHG effect thereof.

5. The biogas collection system according to claim 1, wherein said biogas processing facility is located at said wastewater treatment facility.

6. The biogas collection system according to claim 1, wherein said effluent lines are located in a trench with said biogas pipelines.

7. The biogas collection system according to claim 1 further comprising an air release valve operatively attached to at least one of said one or more effluent lines at a high elevation point, said air release valve hydraulically connected to one of said one or more biogas pipelines to transport a second quantity of biogas from said at least one of said one or more effluent lines to said biogas processing facility for processing thereby.

8. The biogas collection system according to claim 7, wherein said effluent lines are located in a trench with said biogas pipelines.

9. A biogas collection system, comprising:
one or more wastewater sources, each of said wastewater sources generating wastewater;
an interceptor tank hydraulically connected to said one or more wastewater sources, said interceptor tank configured to receive wastewater from said one or more wastewater sources and generate a quantity of effluent and a quantity of biogas;
a wastewater treatment facility configured to process said quantity of effluent;
one or more effluent lines hydraulically interconnecting said interceptor tank and said wastewater treatment facility, each of said one or more effluent lines configured to transport said quantity of effluent to said wastewater treatment facility;
a biogas processing facility configured to receive and process said quantity of biogas so as to beneficially utilize said quantity of biogas and/or reduce the GHG effect thereof, said biogas processing facility located at said wastewater treatment facility;
one or more biogas pipelines interconnecting said interceptor tank and said biogas processing facility, each of said one or more biogas pipelines configured to transport said quantity of biogas to said biogas processing facility; and
an air release valve operatively attached to at least one of said one or more effluent lines at a high elevation point, said air release valve hydraulically connected to at least one of said one or more biogas pipelines to transport a second quantity of biogas from said at least one of said one or more effluent lines to said biogas processing facility for processing thereby.

10. The biogas collection system according to claim 9, wherein said biogas processing facility is a power generation facility configured to generate electricity utilizing said quantity of biogas.

11. The biogas collection system according to claim 9, wherein said biogas processing facility is a combustion facility configured to combust said quantity of biogas to reduce the GHG effect thereof.

12. The biogas collection system according to claim 9, wherein said effluent lines are located in a trench with said biogas pipelines.

13. The biogas collection system according to claim 9, wherein said biogas processing facility comprises a power generation facility configured to generate electricity utilizing a first portion of said quantity of biogas and a combustion facility configured to combust a second portion of said quantity of biogas to reduce the GHG effect thereof.

14. A method of collecting biogas from a wastewater system, said method comprising the steps of:
a) delivering wastewater from one or more wastewater sources to an interceptor tank configured for anaerobic processing of the wastewater;
b) digesting the wastewater inside said interceptor tank to produce a quantity of effluent and a quantity of biogas; and
c) transporting said quantity of effluent from said interceptor tank to a wastewater treatment facility for processing thereby and transporting said quantity of biogas from said interceptor tank to a biogas processing facility for use and/or processing thereby.

15. The method of claim 14, further comprising the step of:
d) generating electricity with said biogas processing facility utilizing said quantity of biogas as a fuel.

16. The method of claim 14 further comprising the step of:
d) combusting said quantity of biogas to reduce the GHG effect thereof.

17. The method of claim 14, wherein said effluent transporting step utilizes one or more effluent lines to transport said quantity of effluent to said wastewater treatment facility and one or more biogas pipelines to transport said quantity of biogas to said biogas processing facility.

18. The method of claim 15, wherein at least one of said effluent lines are placed in a trench with at least one of said biogas pipelines.

19. The method of claim 18, wherein said at least one of said effluent lines has an air release valve hydraulically connected to said at least one of said biogas pipelines to transfer biogas from said at least one of said effluent lines to said biogas processing facility.

20. The method of claim 14, wherein said biogas processing facility is located at said wastewater treatment facility.
